(19) United States
(12) Patent Application Publication
(10) Pub. No.: US 2007/0174326 A1
(43) Pub. Date: Jul. 26, 2007

(54) Application of metadata to digital media

(75) Inventors: Jordan L.K. Schwartz, Seattle, WA (US); Tomasz S.M. Kasperkiewicz, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/338,225

(22) Filed: Jan. 24, 2006

(51) Int. Cl. G06F 7/00

(52) U.S. Cl. 707/102

(57) ABSTRACT

A system, a method and computer-readable media for associating textual metadata with digital media. An item of digital media is identified, and an audio input describing the media is received. The audio input is converted into text. This text is stored as metadata associated with the identified item of digital media.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

In recent years, computer users have become more and more reliant upon personal computers to store and present a wide range of digital media. For example, users often utilize their computers to store and interact with digital images. As millions of families now use digital cameras to snap thousands of images each year, these images are often stored and organized on their personal computers.

With the increased use of computers to store digital media, greater importance is placed on the efficient retrieval of desired information. For example, metadata is often used to aid in the location of desired media. Metadata consists of information relating to and describing the content portion of a file. Metadata is typically not the data of primary interest to a viewer of the media. Rather, metadata is supporting information that provides context and explanatory information about the underlying media. Metadata may include information such as time, date, author, subject matter and comments. For example, a digital image may include metadata indicating the date the image was taken, the names of the people in the image and the type of camera that generated the image.

Metadata may be created in a variety of different ways. It may be generated when a media file is created or edited. For example, the user may assign metadata when the media is initially recorded. Such assignment may utilize a user input interface on a camera or other recording device. Alternatively, a user may enter metadata via a metadata editor interface provided by a personal computer.

With the increasingly important role metadata plays in the retrieval of desired media, it is important that computer users be provided tools for quickly and easily applying desired metadata. Without such tools, users may select not to create metadata, and, thus, they will not be able to locate media of interest. For example, metadata may indicate a certain person is shown in various digital images. Without this metadata, a user would have to examine the images one-by-one to locate images with this person.

A number of existing interfaces are capable of tagging digital media with metadata. For example, metadata editor interfaces today typically rely on keyboard entry of metadata text. However, such keyboard entry can be time-consuming, especially with large sets of items requiring application of metadata. Further, a keyboard may not be available or convenient at the moment when metadata creation is most appropriate (e.g., when an image is being taken).

In addition to entry of textual metadata via a keyboard, audio metadata may be associated with a file. For example, a user may wish to store an audio message along with an image. The audio metadata, however, is not searchable and does not aid in the location of content of interest.

### SUMMARY

The present invention meets the above needs and overcomes one or more deficiencies in the prior art by providing systems and methods for associating textual metadata with digital media. An item of digital media is identified, and an audio input describing the media is received. For example, the item of digital media may be a digital image, and the audio input may include the names of the persons shown in the image. The audio input is converted into text. This text is stored as metadata associated with the identified item of digital media.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWING

The present invention is described in detail below with reference to the attached drawing figures, wherein:

FIG. 1 is a block diagram of a computing system environment suitable for use in implementing the present invention;

FIG. 2 illustrates a method in accordance with one embodiment of the present invention for associating textual metadata with digital media;

FIG. 3 is a schematic diagram illustrating a system for associating textual metadata with digital media in accordance with one embodiment of the present invention;

FIGS. 4 and 5 are screen displays of graphical user interfaces in accordance with one embodiment of the present invention in which textual metadata is applied to digital images;

FIGS. 6A and 6B illustrate a method in accordance with one embodiment of the present invention for converting an audio input into textual metadata; and

FIG. 7 illustrates a method in accordance with one embodiment of the present invention for searching media items in response to an audio search input.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

The present invention provides an improved system and method for associating textual metadata with digital media. An exemplary operating environment for the present invention is described below.

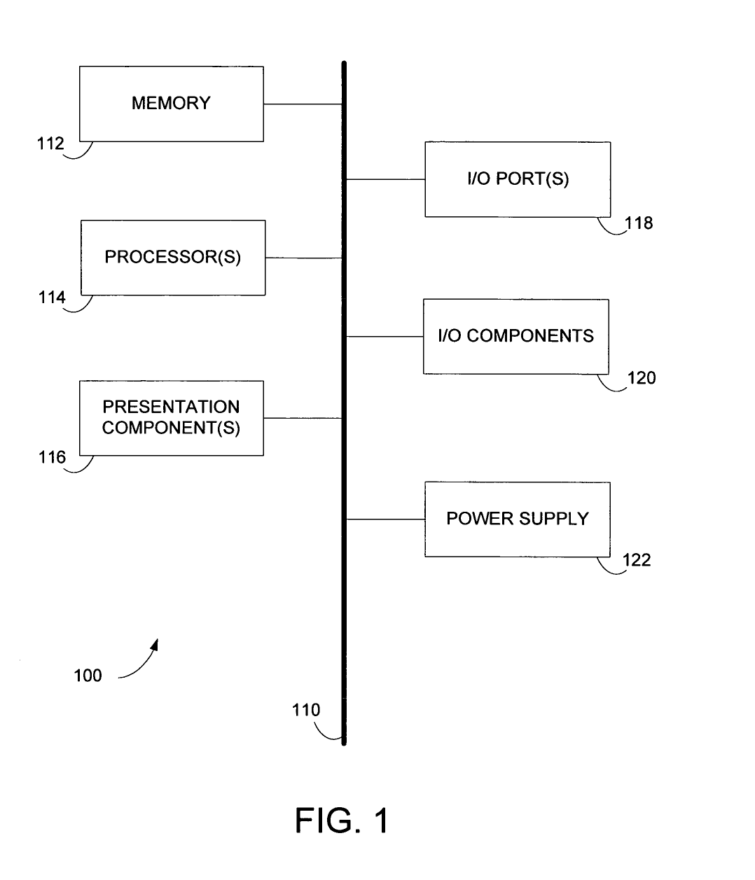

Referring initially to FIG. 1 in particular, an exemplary operating environment for implementing the present invention is shown and designated generally as computing device 100. computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

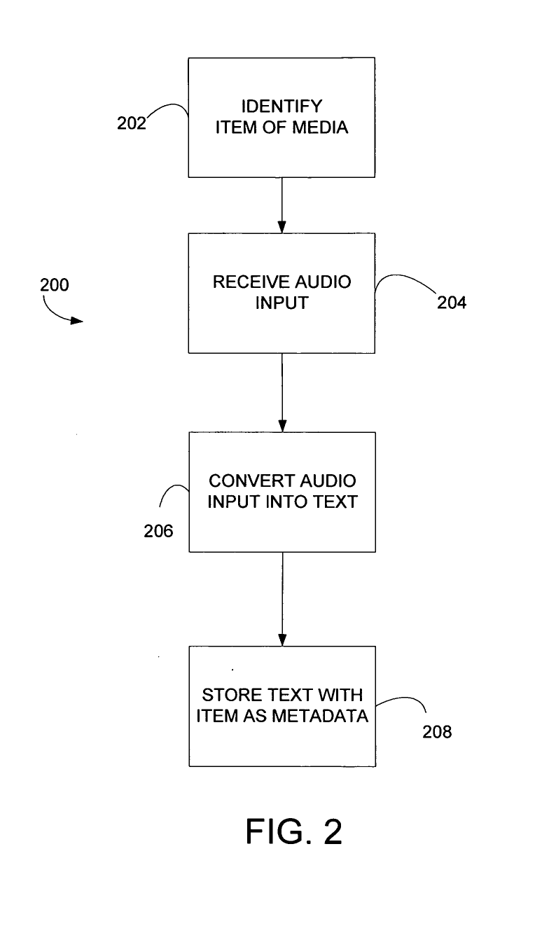

FIG. 2 illustrates a method 200 for associating textual metadata with items of digital media. At 202, the method 200 identifies an item of digital media. For example, the identified media may be an image, a video, a word-processing document or a slide presentation. Those skilled in the art will appreciate that the present invention is not limited to any one type of digital media, and the method 200 may associate metadata with a variety of media types.

At 204, the method 200 receives an audio input describing the identified item of digital media. In one embodiment, the audio input is received when a user speaks into a microphone attached to a computing device. The computing device may host a metadata editor interface that presents the digital media to the user and receives the audio input. In another exemplary embodiment, the audio input may be received when a user speaks into a microphone connected to a device, such as a digital camera. In this embodiment, the user may take a picture and then input speech describing the captured image.

The audio input may contain a variety of information related to the identified media. The audio input may identify keywords related to the subject matter depicted by the media. For example, the keywords may identify the people in an image, as well as events associated with the image. The audio input may also provide narrative information describing the media. In one embodiment, the audio input may also express actions to be performed with respect to the digital media. For example, a user may desire a picture taken with a digital camera be printed or emailed. Accordingly, the user may include the action commands “email” or “print” in the audio input. Subsequently, these action commands may be used to trigger the emailing or printing of the picture. As will be appreciated by those skilled in the art, the audio input may include any information a user desires to be associated with the digital media as metadata or actions a user intends to be performed with respect to the media.

The method 200, at 206, converts the audio input into words of text. A variety of technology exists in the art for converting audio/speech into text. One example of such technology is known as speech (or voice) recognition. With speech recognition, human speech is converted into text, and speech recognition enables the use of voice inputs for entering data or controlling software applications (similar to the way a keyboard or mouse would be used). For example, with a word processor or dictation system using speech recognition, text may be audibly entered into the body of a document via a microphone instead of typing the words on a keyboard or via another input means.

In a typical speech recognition system, a user speaks into an input device such as a microphone, which converts the audible sound waves of voice into an analog electrical signal. This analog electrical signal has a characteristic waveform defined by several factors. To convert the speech into text, the speech recognition engine attempts a pattern matching operation that compares the electrical signal associated with a spoken word against reference signals associated with “known” words. For example, the speech recognition engine may contain a “dictionary” of known words, and each of these known words may have an associated reference signal. If the electrical signal of a spoken word matches the reference signal of a known word, within an acceptable range of error, the system “recognizes” the spoken word as the known word and outputs the text of this known word. Thus, by parsing the audio input into a sequence of spoken words, a speech recognition engine may convert each of these spoken words into text. Those skilled in the art will appreciate that any number of known techniques may be used by the method 200 to convert the audio input into words of text.

In one embodiment, the conversion of the audio input may lead to text that is not strictly a transcription of the spoken input; the conversion may yield an interpretation of the audio input. For example, the converted text may be used to derive a rating for an image. If the user says “five star” or “that's great,” a rating of “5” may be associated with the image. Alternatively, if the user says “one star” or “ugh,” a rating of “1” may be applied. As another example, if user input contains action commands (e.g., edit, email, print), the image may be marked with a tag indicating that the image is to be edited, emailed, printed, ect. As will be appreciated by those skilled in the art, the speech from the audio input may be interpreted and translated in a variety of manners. For example, statistical modeling methods may be used to derive the interpretations of the audio input.

Once the conversion is complete, the words of text may be associated with the identified item of media. Accordingly, the method 200, at 208, stores the words of text as metadata along with the item of digital media. A variety of techniques exist in the art for storing textual metadata with media. In one embodiment, the textual metadata may be used as a tag to identify key aspects of the underlying media. In this manner, items of interest may be located by searching for items having a certain metadata tag. The audio input also may be stored as metadata along with the item of media. In this example, the audio itself will be retained as metadata, as well as its searchable, textual translation.

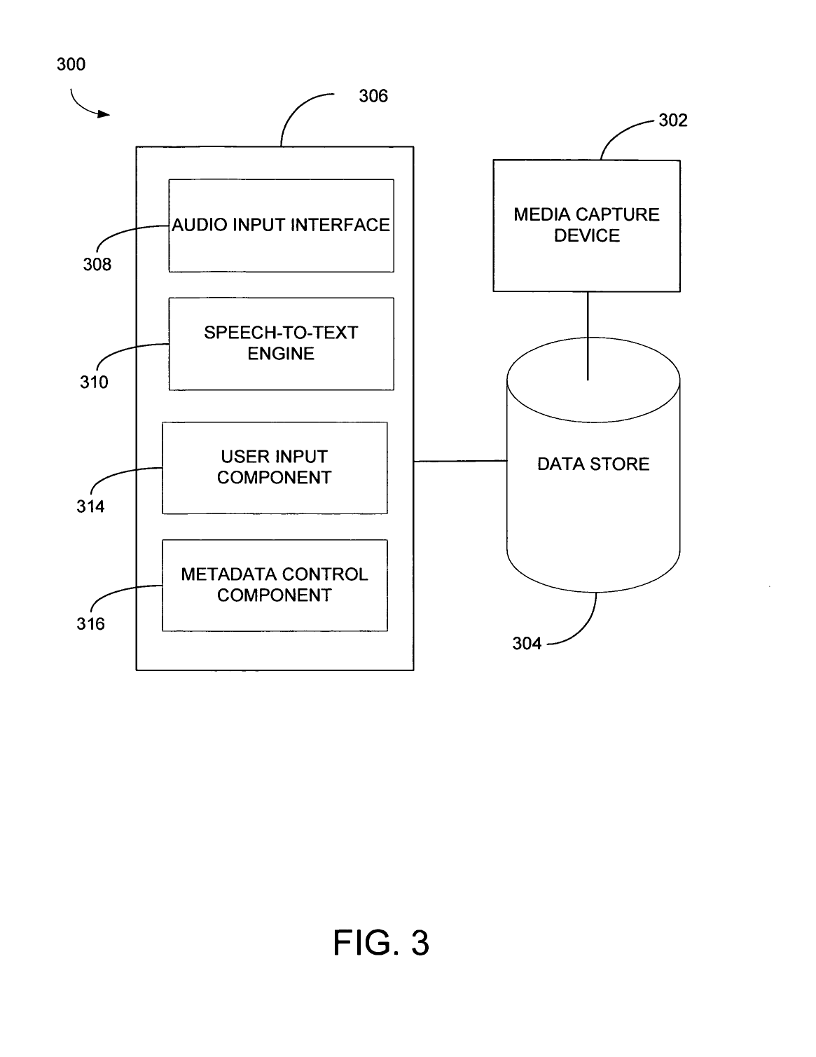

FIG. 3 illustrates a system 300 for associating textual metadata with digital media. The system 300 includes a media capture device 302. The media capture device 302 may be any number of devices configured to capture or receive media. For example, the media capture device 302 may be a camera capable of capturing digital images or video. Once the media is captured, it may be communicated to a data store 304. The data store 304 may be any storage location, and the data store 304 may reside, for example, on a personal computer, a consumer electronics device or a web site. In one embodiment, the data store 304 receives the digital media when a user connects the media capture device 302 to a personal computer that houses the data store 304.

The system 300 further includes a platform 306 configured to associate metadata derived from audio/speech inputs with the digital media. In one embodiment, the platform 306 resides on a personal computer and is provided, at least in part, by an application program or an operating system. The platform 306 may access the data store 304 to identify items of digital media for application of metadata.

The platform 306 includes an audio input interface 308. The audio input interface 308 may be configured to receive an audio input describing an identified item of digital media. In one embodiment, the user may be presented a graphical representation of the media. For example, the user may be presented a digital image. Using a microphone or other audio input device, the user may speak various words that describe the digital image. The audio input interface 308 may receive and store this speech input for further processing by the platform 306.

The platform 306 further includes a speech-to-text engine 310 that is configured to enable the conversion of the audio input into words of text. As previously mentioned, a variety of speech-to-text conversion techniques (e.g., speech recognition) exist in the art, and the speech-to-text engine 310 may use any number of these existing techniques.

As previously mentioned, speech recognition programs traditionally use dictionaries of known words. By finding the known word that most closely matches a speech input, the program converts speech into text. However, conversion errors occur when the program perceives that a word in the dictionary more closely matches the speech input than the word intended by the user. One technique to reduce this error involves limiting the number of words in the dictionary. For example, currently available speech recognition programs use a limited dictionary or “constrained lexicon.” In this mode, the program compares the speech input to only a small set of commands. As will be appreciated by those skilled in the art, the accuracy of the conversion may be greatly increased when using a limited dictionary (i.e., a constrained lexicon).

To reduce conversion errors, the speech-to-text engine 310 may use a listing of previously applied words as a constrained lexicon. The speech-to-text engine 310 may maintain a listing of words previously converted into text and/or applied as metadata. This listing may be updated as a user applies new metadata tags to various items of digital media. As new audio inputs are received, the listing may allow for increased accuracy in speech-to-text conversion. For example, the items of media may include a user's collection of digital images, and certain keywords may be commonly applied to these images. For example, the names of the user's friends and family members may occur frequently, as these people may be the regular subjects of digital images. Accordingly, the speech-to-text engine 310 may first attempt to match a speech input with keywords from the listing. If no acceptable matches are found in the listing, then a broader dictionary/lexicon may be considered.

Once the speech-to-text engine 310 generates a textual conversion of the audio input, this textual conversion may be presented to the user by a user input component 314. Any number of user inputs may be received by the user input component 314. For example, the user may submit an input verifying a correct textual translation of the audio input, or the user may reject or delete a textual translation. Further, the user input component 314 may provide controls allowing a user to correct a translation of the audio input with keyboard or mouse inputs. In sum, any number of controls and inputs related to the converted text may be provided/received by the user input component 314.

The platform 306 further includes a metadata control component 316. The metadata control component 316 may store the converted text as metadata with the identified item of digital media. In one embodiment, once the user has approved a textual metadata tag, the metadata control component 316 may incorporate the tag into the media file as metadata and store the file on the data store 304. Further, the metadata control component 316 may format the metadata so as to identify the type of data being stored. For example, the metadata may indicate that a metadata tag identifies a person or a place. Additionally, the metadata control component 316 may store audio from the audio input along with the media. As will be appreciated by those skilled in the art, the metadata control component 316 may utilize any number of known data storage techniques to associate the textual and audio metadata with the underlying media data.

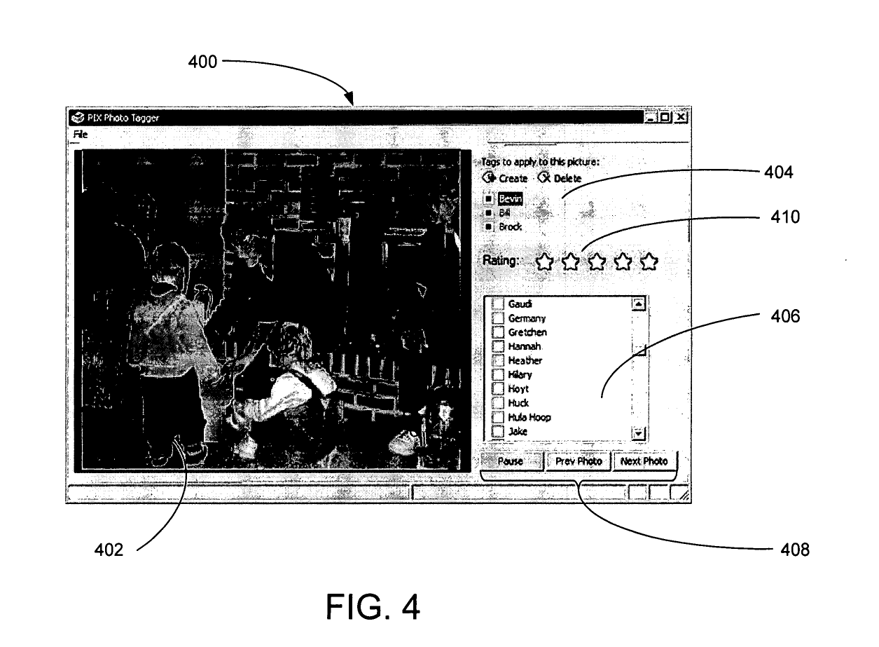

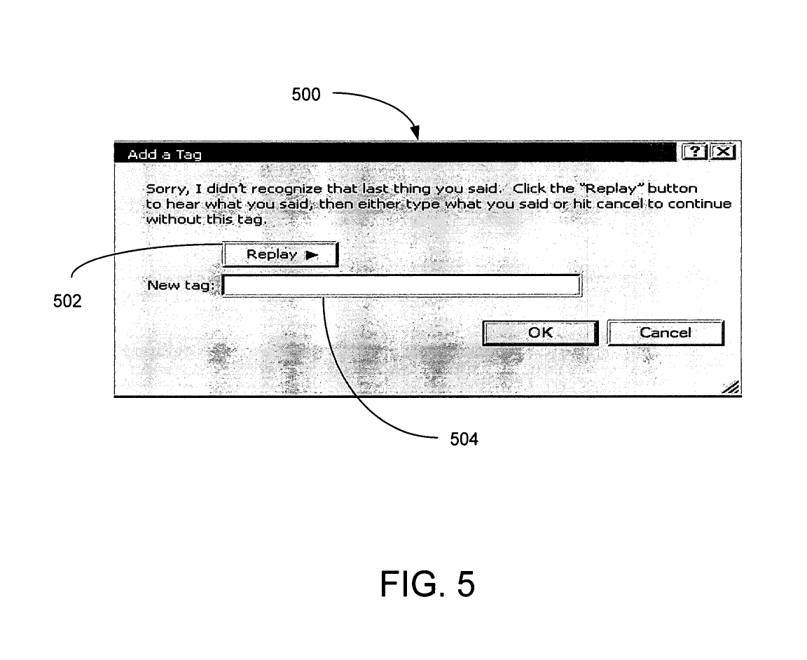

FIGS. 4 and 5 are screen displays of graphical user interfaces in accordance with one embodiment of the present invention. Turning initially to FIG. 4, a screen display 400 is presented. The screen display 400 includes an image presentation area 402. The image presentation area 402 may present an image selected to receive metadata tags. The image presentation area 402 may present a slideshow of images, and the user may submit various inputs, including audio inputs, related to the presented images. For example, the user may indicate a person's name to be stored as a metadata tag along with an image.

The screen display 400 also presents a tag presentation area 404. The tags presented in the tag presentation area 404 may be derived from an audio input associated with the image presented in the image presentation area 402. For example, an audio input may be created by a user in response to the image's display in the image presentation area 402. Alternatively, the audio input may be stored on a digital camera and be communicated to a personal computer along with the presented image. The audio input may be converted into textual tags by a speech-to-text engine, and these tags may be presented in the tag presentation area 404. The tags may identify the subject of the image and/or list actions indicated by the audio input. The tag presentation area 404 also includes controls that allow new tags to be created, tags to be deleted and tags to be edited/corrected. As will be appreciated by those skilled in the art, the tag presentation area 404 may provide a wide variety of controls for manipulating the textual tags to be applied to a digital image.

A manual tag-selection area 406 is also included on the screen display 400. In one embodiment, numerous default or previously applied tags may be presented in the manual tag-selection area 406. As users often re-use previously applied tags, the manual tag-selection area 406 allows users to see and select these previous tags for application to digital images.

The screen display 400 also includes navigation controls 408. Using the navigation controls 408, the user may advance to the next image or go back to a previous image. In one embodiment, audio inputs may be used to control the navigation controls 408. For example, to advance photos, the user may say the word “Next” or may click the “Next Photo” button. As another exemplary control, the navigation controls 408 also include a button to allow the user to pause audio input.

The screen display 400 also includes a rating indicator area 410. For example, the user may select a rating for the presented image; “five stars” may be assigned to a user's favorite images, while “one star” ratings may be given to disfavored images. The ratings may be input via mouse click to the rating indicator area 410. Alternatively, as previously discussed, the rating may be derived from an interpretation of the audio input.

FIG. 5 presents a disambiguation interface 500 that may be used to resolve speech in the audio input that cannot be otherwise understood. For example, the interface 500 may be presented when no words seem to match a speech input or when a user rejects a textual conversion. The interface 500 includes a Replay button 502. The button 502 allows the user to hear audio that was unrecognized. After hearing this audio, the user may input a textual conversion of the audio into a text input area 504. In one embodiment, the text input area 504 may also display existing tags for user selection. As will be appreciated by those skilled in the art, the disambiguation interface 500 allows the user to correct erroneous speech-to-text translations and to manually enter desired metadata tags.

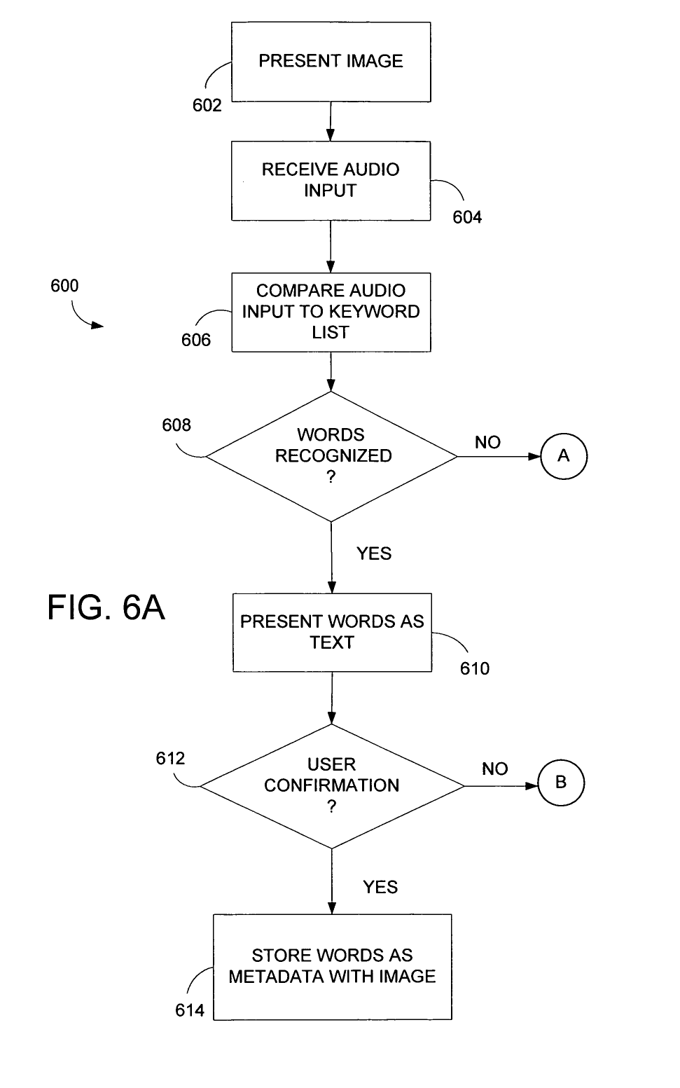

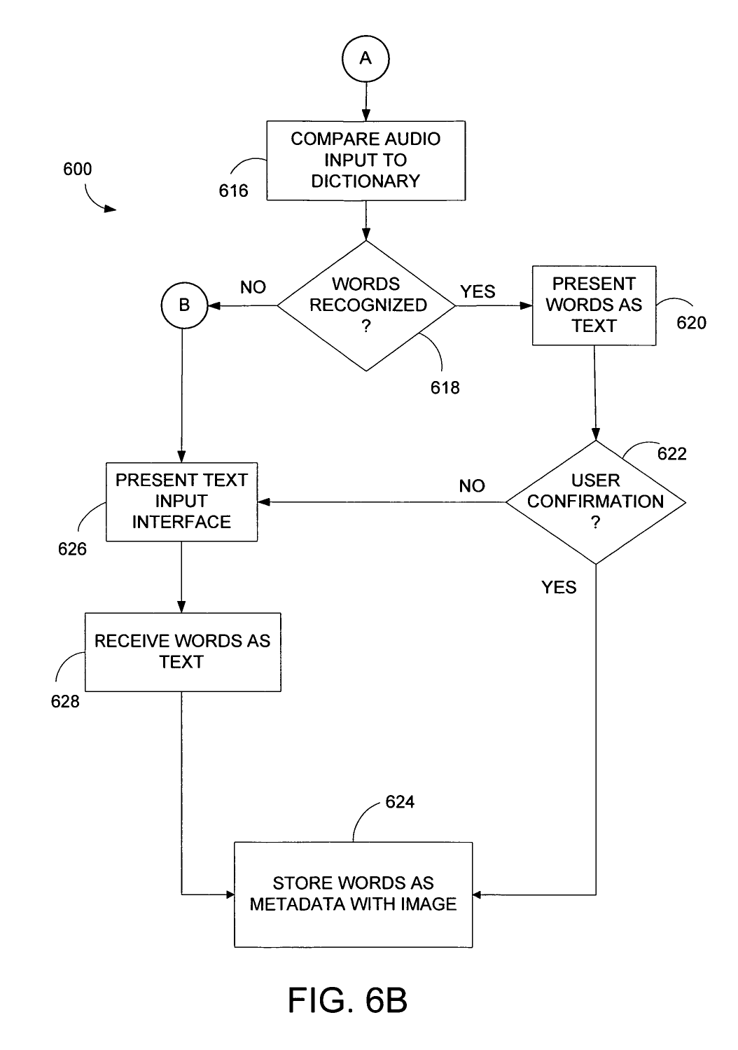

FIGS. 6A and 6B illustrate a method 600 for converting an audio input into textual metadata. At 602, the method 600 presents an image to the user. For example, the image may be presented in an interface such as the image presentation area 402 of FIG. 4. The method 600 receives an audio input at 604. In one embodiment, the user may create the audio input by speaking into a microphone (connected to either a computer or an image capture device). The audio input may include any information or actions a user desires to be associated with the digital image.

At 606, the method 600 compares the words of the audio input to a listing of keywords. As previously discussed, a listing of previously used keywords may be used as a constrained lexicon to improve the accuracy of the speech recognition. At 608, the method 600 determines whether the spoken words were recognized as being keywords.

If the words were recognized as keywords, the method 600 presents the recognized words as text at 610. The user is given the opportunity to confirm a correct conversion of the text at 612. If the user indicates a correct conversion the method 600, at 614, stores the words as textual metadata along with the presented image.

Turning to FIG. 6B, when the words of the audio input are not recognized at 608, the method 600 compares the audio input to a larger dictionary at 616. For example, the comparison may be performed by a speech recognition program in a dictation mode that uses a dictionary containing all words in the English language. While use of this larger dictionary gives rise to greater potential for error, such a dictionary may be useful, for example, when a previously un-used keyword is contained in the audio input.

At 618, the method 600 determines whether the spoken words were recognized as words in the dictionary. If such words were recognized, the method 600 presents the recognized words as text at 620. At 622, the user is given the opportunity to confirm a correct conversion of the speech to text. If a correct conversion is indicated the method 600, at 624, stores the words as textual metadata along with the presented image.

When the words are not recognized at 618, or when the user rejects a conversion at 612 or 622, the method 600 presents a text input interface at 626. For example the text input interface may be similar to the disambiguation interface 500 of FIG. 5. The text input interface may allow the user to hear the audio input and to enter text associated with the audio input. In one embodiment, the text input interface may display words that a speech recognition program identified as being the closest match to the audio input. At 628, the method 600 receives a textual conversion of the audio input. For example, the user may type the text with a keyboard. The method 600 then stores this text as metadata along with the presented image at 624.

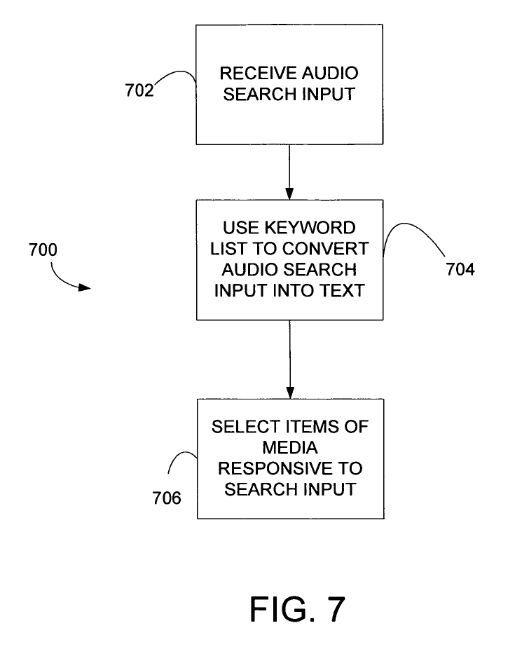

FIG. 7 illustrates a method 700 for locating items of digital media. The method 700, at 702, receives an audio search input. For example, the audio search input may indicate a user's desire to view all digital images having a certain characteristic. The audio search input may be received via any number of audio input means, and any number of user interfaces may facilitate entry of the audio search input.

At 704, the method 700 uses a keyword list to aid in the conversion of the audio search input into text. As previously discussed, a listing of each keyword associated as metadata with items of digital media may be maintained. As one of the primary purposes of metadata is to facilitate searching of items, this listing also represents likely search terms a user may use in a search query. For example, a common metadata keyword may be the name of a family member. When a user desires to see all images containing this family member, the search query will also contain this name. Accordingly, the keyword list may be used as a constrained lexicon to improve the accuracy of the speech-to-text conversion of the audio search input.

Once the audio search input has been converted into text, the method 700, at 706, selects items of media that are responsive to the search input. Any number of known search techniques may be used in this selection, and the selected items may be presented to the user in any number of presentation formats. As will be appreciated by those skilled in the art, use of the keyword listing as a constrained lexicon will yield improved accuracy in the speech-to-text conversion of the audio search query and, thus, will facilitate location of items of interest to a user.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. One or more computer-readable media having computer-useable instructions embodied thereon to perform a method for associating textual metadata with digital media, said method comprising:
receiving an audio input describing an item of digital media stored in a data store;
converting said audio input into one or more words of text; and
storing at least a portion of said one or more words of text as metadata associated with said item of digital media.

2. The media of claim 1, wherein said item of digital media is a digital image or a digital video.

3. The media of claim 2, wherein at least a portion of said one or more words of text identify one or more persons or one or more objects depicted in said digital image.

4. The media of claim 1, wherein said converting said audio input into one or more words of text includes comparing said audio input to a listing of keywords.

5. The media of claim 1, wherein said converting said audio input into one or more words of text includes generating an interpretation of said audio input, wherein said interpretation is represented as said one or more words of text.

6. The media of claim 5, wherein said interpretation indicates a rating associated with said item of digital media.

7. The media of claim 5, wherein said interpretation indicates an action to be performed with respect to said item of digital media.

8. The media of claim 1, wherein method further comprises storing at least a portion of said audio input as metadata associated with said item of digital media.

9. A computer system for associating textual metadata with digital media, said system comprising:
an audio input interface configured to receive one or more audio inputs describing one or more items of digital media;
a speech-to-text engine configured to enable conversion of at least a portion of said one or more audio inputs into one or more words of text; and
a metadata control component configured to store at least a portion of said one or more words of text as metadata associated with at least one of said one or more items of digital media.

10. The system of claim 9, wherein said speech-to-text engine is configured to maintain a listing of keywords.

11. The system of claim 10, wherein said speech-to-text engine is configured to communicate said listing of keywords to a speech recognition program, wherein said speech recognition program selects at least a portion of said one or more words of text from said listing of keywords.

12. The system of claim 10, wherein said listing of keywords includes a plurality words stored as metadata associated with at least a portion of a plurality of items stored in a data store.

13. The system of claim 9, further comprising a user input component configured to present said one or more words of text and further configured to receive one or more user inputs associated with said one or more words of text.

14. The system of claim 9, wherein said speech-to-text engine is configured to utilize a speech recognition program for said conversion.

15. A user interface embodied on one or more computer-readable media and executable on a computer, said user interface comprising:
an item presentation area for displaying a visual representation of an item of digital media;
an audio input interface configured to receive an audio input describing said item of digital media, wherein said audio input is converted into one or more words of text; and
a text presentation interface for displaying said one or more words of text and configured to receive one or more user inputs selecting to store at least a portion of said one or more words of text as metadata associated with said item of digital media.

16. The user interface of claim 15, wherein said text presentation interface displays a listing of keywords.

17. The user interface of claim 15, further comprising a disambiguation interface configured to receive one or more user inputs identifying a textual conversion of said audio input.

18. The user interface of claim 15, wherein said audio input is received from at least one device selected from a listing comprising: a camera; a cellular telephone; a personal computer; a digital photo/video frame; and a portable digital photo/video wallet or locket.

19. The user interface of claim 15, wherein said item of digital media is a digital image.

20. The user interface of claim 19, wherein said item presentation area is configured to receive one or more inputs associating a region of said digital image with at least one of said one or more words of text.
